(19) United States
(12) Patent Application Publication
(10) Pub. No.: US 2006/0262639 A1
(43) Pub. Date: Nov. 23, 2006

(54) Cement based concrete overlay system

(76) Inventor: Wayne E. Bailey, Fredericksburg, VA (US)

Correspondence Address: WAYNE E. BAILEY, P.O. BOX 3447, FREDERICKSBURG, VA, 22402, US

(21) Appl. No.: 11/133,035

(22) Filed: May 20, 2005

(51) Int. Cl. B01F 3/12

(52) U.S. Cl. 366/130

(57) ABSTRACT

A cement based pigmented concrete overlay system that is applied in a thin coat to resurface and add design to unsightly concrete substrates, delivered in a multi-use packaging system. The shipping, water measuring and mixing system utilizes a plastic bucket with watertight lid as the shipping container. Inside the shipping container are the individually packaged ingredients of the overlay system, after the shipping container is emptied of the individually packaged ingredients, it becomes the mixing bucket. The individually packaged ingredients consist of a plastic watertight bottle of concrete primer, which after emptying becomes the exact water measurment vessel. A plastic watertight bag of the dry cement mix, and a plastic watertight bottle of sealer is included. Water is added into the mixing bucket and then the dry cement mix is added, which is then blended to become the overlay mix. The overlay mix is applied to the primed concrete substrate and allowed to dry becoming the overlay surface. The sealer is then applied for protection and appearance.

### REFERENCES CITED

| | | | |
|---|---|---|---|
| 5011903 | April, 1991 | Lymburner | 528/76 |
| 6167668 | January, 2001 | Fine | 52/403 |
| 5320851 | June, 1994 | DeMars | 424/451 |
| 6609636 | August, 2003 | Petriekis | 222/105 |
| 5588532 | December, 1996 | Pharo | 206/522 |
| 5758818 | June, 1998 | Ewing, Jr | 229/120 |
| 6343458 | February, 2002 | Merrell | 53/400 |
| 6372038 | April, 2002 | Kameta | 106/724 |
| 6655524 | December, 2003 | DeLaforcade | 206/222 |
| 5776243 | July, 1998 | Goodson | 106/677 |
| 6348093 | February, 2002 | Rieder | 106/724 |
| 4075711 | February, 1978 | Hall | 259/160 |
| 4904711 | February, 1990 | Sellstrom | 523/466 |
| 6298984 | October, 2001 | Weaver | 206/222 |
| 5695811 | December, 1997 | Anderson | 427/133 |
| 5996304 | December, 1999 | Barker | 52/741 |
| 6554465 | April, 2003 | Crusco | 366/3 |
| 5162060 | November, 1992 | Bredow | 106/808 |
| 5498683 | March, 1996 | Kim | 526/320 |
| 4661161 | April, 1987 | Jakacki | 106/648 |
| 4815603 | March, 1998 | Cunningham | 523/521 |

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

This Invention relates to the packaging and product system that delivers a unique self-contained and user friendly cement based, pigmented concrete overlay system.

The packaging portion of the invention is made up of a plastic bucket with a water tight lid and carrying handle that begins as a master shipping container then becomes the mixing bucket when emptied of its contents, which are the components of the concrete overlay system.

One of the three components packaged inside the master shipping container is the primer which is shipped in its own primer container with its own water tight seal, after the primer is applied to the concrete substrate, the primer container is rinsed out and the primer container is converted to the exact water measurment vessel to be used as the fool-proof method of adding the precise amount of water to the concrete overlay mix.

The second of the three components packaged inside the master shipping container is the dry mix which is packaged in its own water tight dry mix container.

The third of the three components packaged inside the master shipping container is the concrete overlay sealer, packaged inside its own water tight sealed container. The clear concrete overlay sealer, which is applied onto the concrete overlay serves as a surface protector and appearance enhancing coating.

This invention is unique in that all ingredients that are necessary for the complete concrete surface priming application, the colored concrete overlay application and overlay sealing application are individually packaged inside the master shipping container which serves as sales device, shipping device, storage device, water measuring device(primer container), mixing device, holding and pouring device and clean-up bucket device.

As a sales device, the master shipping container serves multiply purposes, whether in photographs, web site ads, on a display shelf in a home improvement store or on display at a home and garden show, the master shipping container provides protective and unique marketing packaging. The master shipping container solves the problem of plastic lined paper bags that many competitors use for shipping their cement products, when mishandled or punctured, the plastic lined paper bags may leak cement dust or allow dampness to enter into the cement bag and compromise the integrity of the contents. The master shipping container is protective of the environment and provides safe packaging due to its rigid shock resistant and waterproofing qualities.

As a shipping device the master shipping container does not require an additional layer of exterior protective packaging to be accepted by freight handlers or package delivery services during shipping and handling. The master shipping container may even be far superior to any card board, paper bag or plastic sheet wrapping that is often used by others. When shipping multiply containers the master shipping container is well designed for stacking on freight pallets to be handled by forklifts and material handling equipment.

As a storage device the master shipping container allows its contents, the cement based concrete overlay system to be resistant to outside contamination, dampness intrusion, rough handling and it is crush resistant from other items being stacked against it or on top of it. The master shipping container can be dropped off of a shelf or thrown into a swimming pool and still protect the cement based concrete overlay system. Rodents and insects find it much harder to invade a plastic bucket then a plastic lined bag. In addition to the unique storage and stacking qualities of the master shipping container, the individual packaging of the cement based concrete system ingredients inside the master shipping container also perform multiply tasks that are unique in the field of concrete overlays. The primer container with water tight seal, containing the concrete primer is unique in several ways. First, this invention is the first to include pre measured primer in its own package of concrete overlays. Second, once the primer has been applied onto the concrete substrate prior to the overlay mix application, the primer container is rinsed out with clean water and then the primer container becomes the exact water measurment vessel (measuring device), which is then filled full to the brim with the exact amount of water which is to be poured into the mixing bucket and then blended with the dry mix.

Exact measurements of each componet of this invention has been provided. The individual packaging of the dry cement mix with pigment is contained in a water tight dry mix container that serves to protect the mix from contamination, moisture and leakage.

The concrete sealer is contained in a separate water tight sealer container that secures and protects the sealer till it is applied over the overlay surface as the last step of the cement based concrete overlay system.

The master shipping container once emptied of all components of the cement based concrete overlay system will convert to the mixing bucket, which will receive the exact measurment of water and the dry mix to be blended into the overlay mix. The mixing bucket then becomes the holding and pouring bucket which serves as the container for the overlay mix during the application to the primed concrete substrate. Once the application is complete the holding and pouring bucket may be used for clean-up and then other purpouses.

### BRIEF SUMMERY OF THE INVENTION

It is the primary object of this invention to provide a cement based concrete overlay system with pigment consisting of packaging and product.

It is another object of this invention to provide a master shipping container in which all components of the system are placed for shipping. The master shipping container is a plastic bucket with a watertight sealing lid and handle.

It is another object of this invention to provide a mixing bucket which is converted from the master shipping container once it is emptied of its contents and then it serves as the container for blending and mixing the pre-measured dry mix and pre-measured water.

It is another object of this invention to provide a holding and pouring bucket, which is converted from the mixing bucket once the pre-measured dry mix and pre-measured water is completely blended and mixed. The blended mix is held in the holding and pouring bucket till time of overlay application, and then the bucket is turned bottom up to allow the blended mix to pour onto the primed substrate. The bucket may then be rinsed out to be used to clean up tools and then be used for other uses.

It is another object of this invention to provide a primer container which contains the primer for the overlay system. The primer container is a plastic vessel with a water tight seal and is delivered inside the master shipping container.

It is another object of this invention to provide a exact water measurment vessel which is converted from the primer container, that after the primer is applied to the substrate and the primer container is cleaned out, it is converted to a measuring device used for adding the exact amount of water to the mix.

It is another object of this invention to provide a sealer container which contains the overlay sealer, a component of the overlay system. The sealer container is a plastic vessel with a water tight seal and is delivered inside the master shipping container.

It is another object of this invention to provide a dry mix as a component of the cement based concrete overlay system. The dry mix is composed of measured amounts of type three gray or white Portland cement, class A quartz sand, dry polymer powder, lime stone powder, glass beads, and synthetic pigments.

It is another object of this invention to provide that the synthetic pigments, when introduced into the dry mix in pre determined measured quantities and specific colors or blends of colors, produce a broad selection of cement based concrete overlay color choices. The multitude of color choices as part of the cement based concrete overlay system, expands the systems uniqueness.

It is another object of this invention to provide a primer as a component of the cement based concrete overlay system which is applied to the concrete substrate as step one, after the concrete substrate has been properly cleaned and prepared for the concrete overlay.

It is another object of this invention to provide that the dry mix as a component of the cement based concrete overlay system is blended with a exact amount of water using the exact water measurment vessel to deliver such water to the mixing bucket first, and then adding the dry mix second, as both are completely blended inside the mixing bucket using excepted mixing tools and procedures.

It is another object of this invention to provide that the concrete overlay mix as part of the cement based concrete overlay system is applied to the previously primed concrete substrate.

It is another object of this invention to provide that the concrete overlay mix is applied to the primed concrete substrate using a verity of techniques including trowel, roller, sprayer, brush, broom or rake to achieve multi finish designs.

It is another object of this invention to provide that the concrete overlay as part of the cement based concrete overlay system, may serve as a technique to add designs, repairs, resurface, reface, and refresh existing undesirable, damaged or unsightly concrete substrates.

It is another object of this invention to provide that the concrete overlay may be applied using multi-layers and or multi-colors to achieve desired designs and textures for identification, safety warnings and advertising.

It is another object of this invention to provide that after the concrete overlay has been applied to the primed concrete substrate and allowed to dry and cure, the concrete overlay mix will become the concrete overlay surface.

It is another object of this invention to provide that the sealer, as part of the cement based concrete overlay system is applied on top of the concrete overlay surface as a protective coat and final step of the cement based concrete overlay system.

It is another object of this invention to provide that the sealer as part of the cement based concrete overlay system when applied serves to harden, strengthen, and protect by sealing the installed overlay surface.

It is another object of this invention to provide that the mixing and application instructions are part of the cement based concrete overlay system and are delivered inside the master shipping container. The mixing and application instructions provide information necessary from start to finish to properly install the cement based concrete overlay system.

### BRIEF DESCRIPTION OF DRAWING

FIG. 1a is a front view of the bucket which is refereed to as the master shipping container 1 and includes a self sealing watertight lid 2 and attached handle 3. The master shipping container 1 serves as the device for shipping and containment of the ingredient containers of the overlay system. The master shipping container 1 when emptied of its contents will serve as the mixing bucket 8 at the job site.

FIG. 1b is a front view of the dry mix container 4, which is a watertight plastic bag for containing the dry mix of the overlay system and serves to separate and protect the contents from moisture and contamination.

FIG. 1c is a front view of the primer container 5 which is a watertight plastic jug with lid for containing the primer of the overlay system and after being emptied, becomes the exact water measurment vessel 9 to be used to add the precise amount of water for blending with the dry mix to produce the overlay mix.

FIG. 1d is a front view of the sealer container 6, which is a watertight plastic jug with lid for containing the sealer of the overlay system.

FIG. 1e is a front view of the folded mixing and application instructions 7.

FIG. 2 is a front view of the master shipping container 1, master shipping container lid 2 and master shipping container handle 3 in the packaged and shipping configuration. Inside the master shipping container 1 is the dry mix container 4, primer container 5, sealer container 6 and the folded mixing and application instructions 7.

FIG. 3 is a block flow diagram illustrating the sequence of steps that comprise the method of the cement based concrete overlay system.

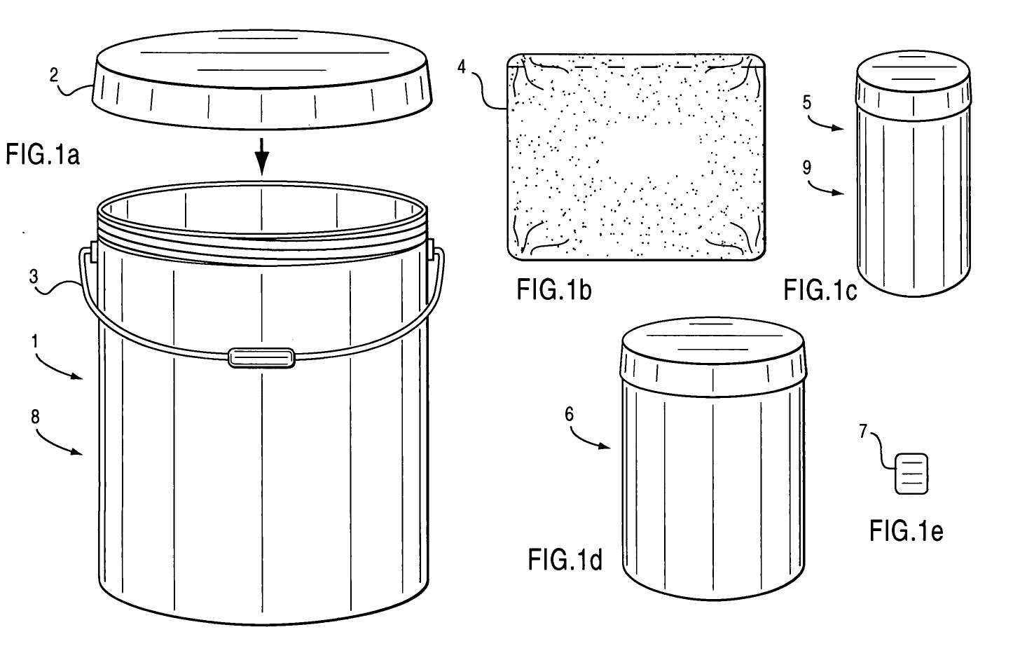

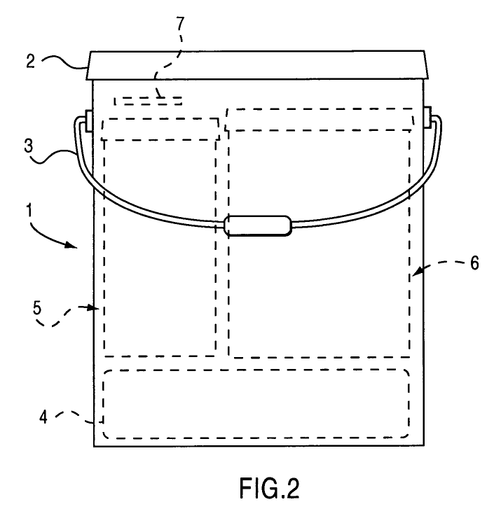

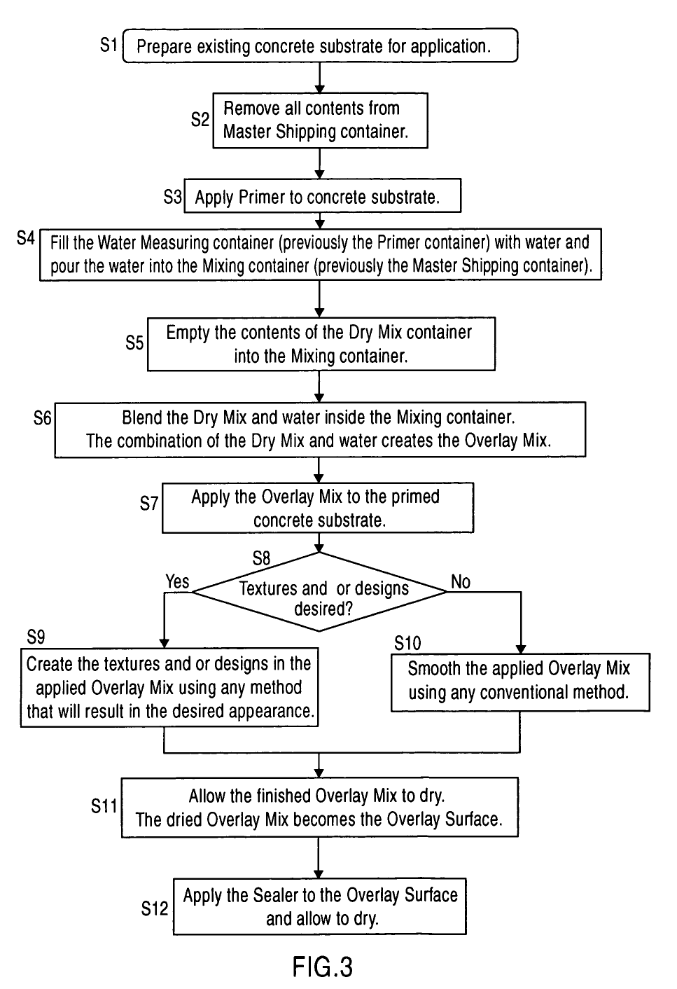

### DETAILED DESCRIPTION OF THE INVENTION

(A) The cementanious concrete overlay system contains a blend of ingredients which include all such dry compounds that are blended into the dry mix of the system.

Portland cement type three hydraulic cement in either gray color or white color powder form containing in its composition hydraulic calcium silicates contained in a crystalline mass, not separable into individual components. Major compounds are; Tricalcium Silicate, Dicalcium Silicate, Tricalcium Aluminate, Tetracalcium aluminoferrite, Calcium Sulfate dihydrate. Portland cement type three produces high early strength qualities required in this cementanious overlay system.

Latex dry redispersible white polymer water-soluble powder with a free flowing consistency containing Vinylacetate/Ethylene-copolymers as the polymer base. The latex polymer powder as an additive enhances the properties of dry cement blends by increasing adhesion to difficult substrates, improving workability, lower water consumption, better abrasion resistance and greater impact resistance. The latex polymer powder dry system adds the convenience, reliability and handling and storage advantages of a dry powder system while improving tensile, compression, and flexural strength, as well as the transversal deformation.

Quartz sand which has been cleaned, dried and graded from 0.5 mm to 0.063 mm size range is used as a aggregate in the cement overlay system. The smallest of the quartz sand (0.063 mm) and the larger size of the quartz sand (0.5 mm) produce a denser matrix by filling voids which may occur in mix designs with larger aggregate. The smaller quartz sand size also can increase compressive strength and flowing ability. The quartz sand represents the largest amount of aggregate by weight in the cement overlay mix.

Ceramic micro spheres graded from 0.5 mm to 0.063 mm size range add a higher degree of performance in terms of wetting, leveling, and hardness when blended with the quartz sand and type three Portland cement. The ceramic/glass micro spheres are inert and environmentally pure with no free silica.

Limestone powder (calcium oxide) graded from 0.5 mm to 0.063 mm increases strength, workability and bond strength to the cement overlay mix.

Coloring of the cement overlay mix is produced by the introduction of Iron Oxide Pigments which normally are made up of three different Iron Oxide Minerals: 1. Goethite (yellow Iron Oxide) 2. Hematite (Red Iron Oxide) 3. Magnetite (Black Iron Oxide). These minerals can be produced naturally by geologic activities or can be synthetically produced in chemical reactions. The synthetically produced Iron Oxide pigments are preferred for this cement design.

Pigment-to-cement ratio should not exceed 15%.

The list of major ingredients for the dry portion of the cement based concrete overlay system is as follows:

1. Portland Cement, Type Three (White or Gray color)

2. Latex Dry Redispersible Polymer Powder

3. Quartz Sand

4. Ceramic or Glass Micro spheres

5. Lime Stone Powder

6. Iron Oxide Pigments

7. Water

(B) The cementanious overlay system contains a liquid primer which consist of a mix of water, concentrated liquid copolymer. Its major components are Propylene Glycol and Polymer Solids. The benefits of first applying the primer to the concrete substrate before applying the overlay is to increase bond strength, improve workability and stabilize the bonding surfaces.

(®) The cementanious overlay system contains a liquid sealer which consist of a water based, modified acrylic curing, sealing and hardening compound to provide a transparent protective film over the new cementanious overlay. The sealer is transparent and can be formulated to produce a low sheen, medium sheen or a high gloss surface. The sealer may be applied by sprayer, short napped roller, brush or push broom.

(D) Included in each container of the cement based concrete overlay system is a copy of the mixing and application instructions that explain the proper steps necessary to understand and use this product along with helpful installation tips and design ideas.

1. The packaging and product system of the cement based concrete overlay, said system comprising:

2. The master shipping container of claim 1 which consists of a plastic bucket with a self-sealing watertight lid and handle that serves as the sales and shipping device that also is a protective enclosure for the overlay components.

3. The master shipping container of claim 1 converts into the mixing bucket after all contents have been removed and is the container for mixing the dry mix with water and holding such mix prior to the overlay application.

4. The primer container of claim 1 which is the exact sized plastic bottle with watertight seal for containing the primer which is a componet of the system.

5. The primer container of claim 1 converts into the exact water measurment vessel, which is sized to add the proper amount of water to the dry mix when water is filled to its brim, making the addition of water mistake proof.

6. The dry mix container of claim 1 is a watertight plastic bag that contains the dry mix, a componet of the system.

7. The sealer container of claim 1 which is the exact sized plastic bottle with watertight seal for containing the sealer which is a componet of the system.

8. The primer of claim 1 is a water based liquid copolymer with major components of propylene glycol and polymer solids that increases bond strength between the concrete substrate and the cement based concrete overlay.

9. The cement based concrete overlay dry mix of claim 1 is comprised of the following major ingredients:
(A) High early strength type three Portland cement in either gray or white color (to aid in the overlay coloration design). The Portland cement has the following major ingredients added for strength and workability.
1. Tricalcium Silicate
2. Dicalcium Silicate
3. Tricalcium Aluminate
4. Tetracalcium Aluminoferrite
5. Calcium Sulfate
(B) Class A quartz sand sized from 0.063 mm to 0.5 mm
(C) Dry latex redispersible polymer powder including the following major ingredients:
1. Vinylacetate
2. Ethylene copolymers
(D) Lime stone powder sized from 0.063 mm to 0.5 mm
(E) Ceramic/glass micro spheres sized from 0.063 mm to 0.5 mm
(F) Iron oxide pigments from synthetic iron oxide

10. The sealer of claim 1 is a water based, high solids modified acrylic sealing and hardening compound which provides a protective film that has the following major ingredients.
1. Acrylic Copolymer
2. Aromatic Hydrocarbon

11. The mixing and application instructions of claim 1 which is a component of the cement based concrete overlay system.
